(19) United States
(12) Patent Application Publication
(10) Pub. No.: US 2024/0235451 A9
(43) Pub. Date: Jul. 11, 2024

(54) POWER CONVERSION DEVICE

(71) Applicant: Mitsubishi Electric Corporation, Tokyo (JP)

(72) Inventor: Tomonori YAMADA, Tokyo (JP)

(73) Assignee: Mitsubishi Electric Corporation, Tokyo (JP)

(21) Appl. No.: 18/469,843

(22) Filed: Sep. 19, 2023

(30) Foreign Application Priority Data
Oct. 24, 2022 (JP) 2022-169605

(51) Int. Cl. H02P 27/06; B60L 15/20; H02P 29/024; H02P 29/60

(52) U.S. Cl. CPC H02P 27/06; B60L 15/20; H02P 29/027; H02P 29/60; B60L 2210/42; B60L 2240/421; B60L 2240/423; B60L 2240/425; H02P 2201/11

(57) ABSTRACT

A loss in each of a converter, an inverter, and a motor changes according to operation based on the rotation speed of the motor or the like. Thus, in order to efficiently perform operation, appropriate control needs to be performed according to the voltage of a DC power supply and operation of the motor. The present disclosure is characterized by including a controller which controls a switching element of a converter according to the torque and the rotation speed of a motor on the basis of a loss in at least one of the motor, an inverter, and the converter.

### BACKGROUND OF THE INVENTION

### 1. Field of the Invention

The present disclosure relates to a power conversion device.

### 2. Description of the Background Art

An electric automobile is provided with a power converter having: an inverter circuit; a voltage converter circuit; and a power controller. As such a power converter, a power converter has been known in which a voltage converter circuit has a high-voltage end connected to a battery and a low-voltage end connected to an inverter circuit, switching control is performed on the voltage converter circuit such that the voltage of the low-voltage end becomes lower than the voltage of the high-voltage end if the value of current flowing through the inverter circuit or power consumed in a motor is smaller than a threshold value, and switching control (through direct-connection operation) is performed such that the voltage of the low-voltage end becomes equal to the voltage of the high-voltage end if the value of current flowing through the inverter circuit or power consumed in the motor is larger than the threshold value (see, for example, Patent Document 1).
Patent Document 1: Japanese Patent No. 6954205

A power converter for an electric automobile has a large heat generation amount since large current flows through the power converter. In particular, if the torque outputted by a motor is high and the rotation speed thereof is high, current flowing through the power converter also increases, whereby the heat generation amount increases. In a chopper-type voltage converter circuit, pulsating current is generated in association with ON/OFF of a switching element, and the switching element itself and a reactor generate heat. Meanwhile, if the torque outputted by the motor is low and the rotation speed thereof is low, the converter circuit sometimes generates a larger amount of heat than the inverter circuit. In a case where the power converter includes the converter circuit, the efficiencies of (losses in) the converter circuit, the inverter circuit, and the motor change according to operation. Therefore, control based on the threshold value of power consumed in the traveling motor described in Patent Document 1 has a problem that operation cannot be efficiently performed unless control is appropriately performed according to the voltage of a DC power supply and operation of the motor as in a case where, for example, direct-connection operation cannot be performed at a low torque and a low rotation speed that are equal to or smaller than threshold values.

### SUMMARY OF THE INVENTION

The present disclosure has been made to solve the above problem, and an object of the present disclosure is to provide a power conversion device having high efficiency through reduction in heat generation amount by appropriately controlling a converter on the basis of the efficiency of (loss in) an electric automobile based on an operation state.

A power conversion device according to the present disclosure is a power conversion device for converting power of a DC power supply into drive power for a traveling motor, the power conversion device including: an inverter which supplies AC power to the traveling motor; a converter which controls switching of a switching element and applies a voltage of the DC power supply to the inverter; and a controller which controls the converter, wherein the controller is configured to control the switching element according to a torque and a rotation speed of the traveling motor on the basis of a loss in at least one of the traveling motor, the inverter, and the converter.

In the power conversion device according to the present disclosure, the switching element is controlled on the basis of the loss in at least one of the traveling motor, the inverter, and the converter. Consequently, the heat generation amount of the converter can be reduced, and power conversion can be performed with high efficiency.

### BRIEF DESCRIPTION OF THE DRAWINGS

FIG. 1 is a block configuration diagram of a power conversion device according to a first embodiment;

FIG. 2 shows an example of an output voltage map for a voltage converter of the power conversion device according to the first embodiment;

FIG. 3 is a flowchart of a process for determining an output voltage of the voltage converter of the power conversion device according to the first embodiment;

FIG. 4 is a block configuration diagram of a power conversion device according to a second embodiment; and

FIG. 5 shows an example of a hardware configuration of each of a power controller and a higher-order controller in the power conversion devices according to the embodiments.

### DETAILED DESCRIPTION OF THE PREFERRED EMBODIMENTS OF THE INVENTION

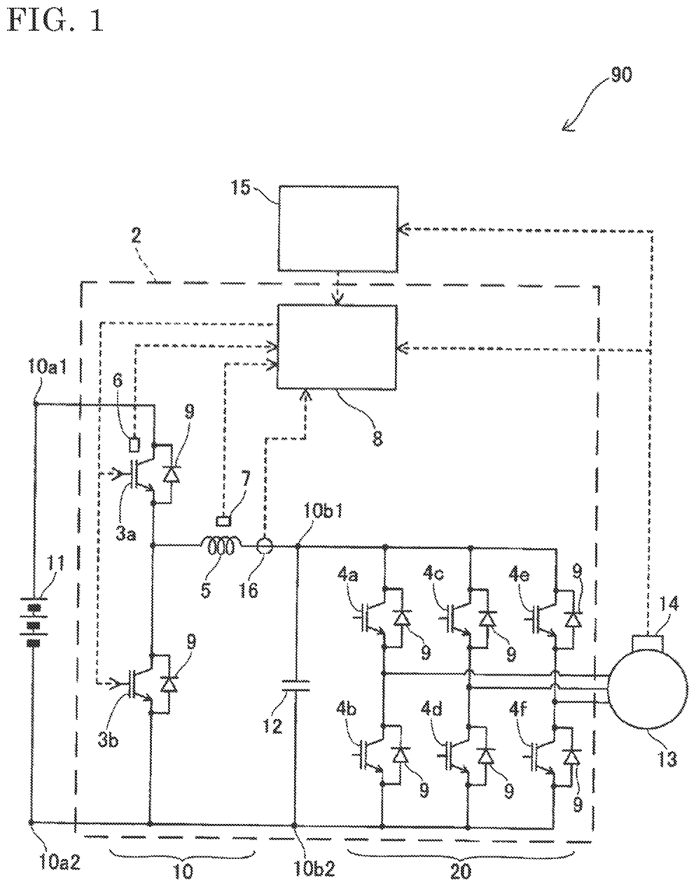

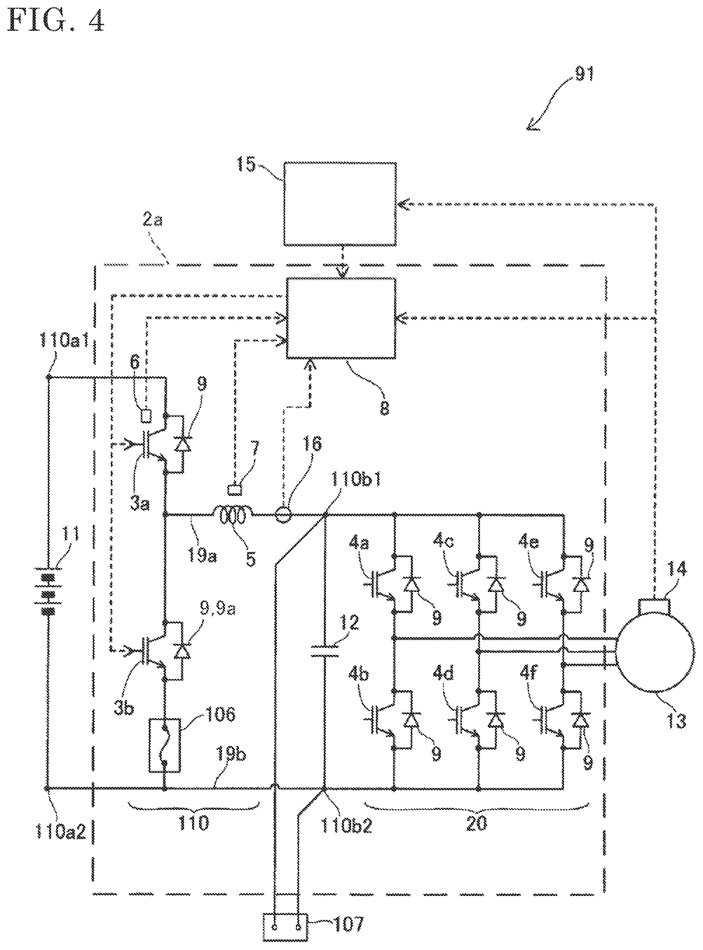

Hereinafter, suitable embodiments of the power conversion device according to the present disclosure will be described with reference to the drawings. The same features and corresponding parts are denoted by the same reference characters, and detailed descriptions thereof will be omitted. In the subsequent embodiments as well, redundant descriptions of components denoted by the same reference characters will be omitted. Among descriptions of FIG. 1 and FIG. 4 and the configurations shown in these drawings, descriptions of configurations similar to those in Patent Document 1 are given by citing corresponding descriptions in Patent Document 1.

### First Embodiment

FIG. 1 is a block configuration diagram of a power conversion device. An electric automobile 90 includes a battery 11 as a DC power supply, a power converter 2, a higher-order controller 15, and a traveling motor 13 and travels by driving the motor 13 with power of the battery 11. The power converter 2 is connected between the battery 11 and the motor 13, and converts DC power outputted by the battery 11 into AC power that is suitable for driving the motor 13. Broken-line arrows in FIG. 1 indicate signal lines. However, signal lines from a power controller 8 to switching elements 4a to 4f are not shown. It is noted that the voltage of the battery 11 may be 500 V or higher. This is because a loss ameliorating effect for the converter due to a non-boosting effect is increased in a case where a region of variable voltage is large, i.e., a variable gear ratio is high.

The power converter 2 includes a voltage converter circuit 10, an inverter circuit 20, and the power controller 8. A high-voltage end positive electrode 10a1 and a high-voltage end negative electrode 10a2 of the voltage converter circuit 10 are connected to the battery 11. In addition, a low-voltage end positive electrode 10b1 and a low-voltage end negative electrode 10b2 of the voltage converter circuit 10 are connected to the inverter circuit 20. In the following descriptions, the high-voltage end positive electrode 10a1 and the high-voltage end negative electrode 10a2 are collectively referred to as a high-voltage end 10a, and the low-voltage end positive electrode 10b1 and the low-voltage end negative electrode 10b2 are collectively referred to as a low-voltage end 10b.

The voltage converter circuit 10 has a step-down function of stepping down a voltage applied to the high-voltage end 10a and outputting the resultant voltage to the low-voltage end 10b, and a step-up function of stepping up a voltage applied to the low-voltage end 10b and outputting the resultant voltage to the high-voltage end 10a, and constitutes a bidirectional DC-DC converter. The voltage applied to the low-voltage end 10b refers to the voltage of regenerative power obtained by reversely driving the motor 13 with use of deceleration energy of the vehicle.

The voltage converter circuit 10 is formed as a chopper-type one. Switching elements 3a and 3b are connected in series between the high-voltage end positive electrode 10a1 and the high-voltage end negative electrode 10a2. A diode 9 is connected in antiparallel to each of the switching elements 3a and 3b. A reactor 5 is connected between the low-voltage end positive electrode 10b1 and an intermediate point between the switching elements 3a and 3b connected in series. The low-voltage end negative electrode 10b2 and the high-voltage end negative electrode 10a2 are directly connected. It is noted that the voltage converter circuit 10 may be a multilevel converter. The voltage converter circuit may be formed by using a magnetically coupled reactor. In the multilevel converter, the frequency of ripple current in the reactor 5 can be set to be a frequency higher than that of a single chopper, and the necessary inductance can be reduced. Consequently, the size of the reactor 5 can be reduced. However, in the case of the multilevel chopper, step-up is performed after power is accumulated in an intermediate capacitor once. Thus, if the output capacity of the converter is increased, the capacitance of the intermediate capacitor needs to be increased. Meanwhile, in the magnetically coupled reactor, a high inductance can be obtained relative to the size of the reactor at large power, by means of coupling L (inductance). Thus, the magnetically coupled reactor is advantageous to a converter having an increased capacity.

The switching element 3a is involved in step-down operation, and the switching element 3b is involved in step-up operation. The switching elements 3a and 3b are operated in a mutually complementing manner such that, when one of the switching elements is turned on, the other one is turned off. The voltage converter circuit 10 is operated such that the voltage ratio between the high-voltage end 10a and the low-voltage end 10b becomes a target voltage ratio. A direction in which current flows is determined depending on balance between the voltage on the high-voltage end 10a side and the voltage on the low-voltage end 10b side.

The switching elements 3a and 3b are controlled by the power controller 8. The voltage converter circuit 10 includes: a temperature sensor 6 which measures the temperature of the switching element 3a; a temperature sensor 7 which measures the temperature of the reactor 5; and a current sensor 16 which measures current flowing through the reactor 5. Measurement data from each of the temperature sensors 6 and 7 and the current sensor 16 is transmitted to the power controller 8. The power controller 8 controls current to flow through the voltage converter circuit 10, such that overheating is suppressed at the switching element 3a and the reactor 5. As each of the switching elements 3a and 3b, there is a metal-oxide-semiconductor field-effect transistor (MOSFET), an insulated gate bipolar transistor (IGBT), a thyristor, or the like, but a wide bandgap semiconductor made of SiC or the like may be used.

In the case of the chopper-type voltage converter circuit 10, the switching element 3a involved in step-down only has to be maintained to be in an ON state in order to set the voltage of the high-voltage end 10a and the voltage of the low-voltage end 10b to be equal to each other. Meanwhile, in the case of the bidirectional DC-DC converter, direct-connection operation can be performed by maintaining the switching element 3a involved in step-down to be in an ON state and maintaining the switching element 3b involved in step-up to be in an OFF state. In the case of direct-connection operation, no pulsating current is generated, and heat generation from the switching elements 3a and 3b and the reactor 5 can be suppressed.

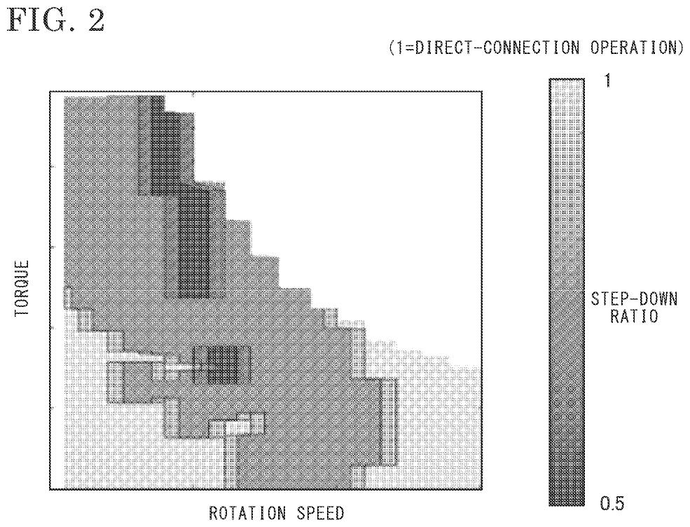

The power controller 8 controls the voltage converter circuit 10 so as to improve the efficiency of the electric automobile 90, by referring to a map. The map is, for example, a loss map in which loss is indicated on a TN chart having a horizontal axis representing the rotation speed of the motor and a vertical axis representing the output torque of the motor as shown in FIG. 2. In the present embodiment, step-down ratios at which the loss is minimum (the efficiency is maximum) are indicated on the TN chart. FIG. 2 shows the step-down ratios according to the color intensity. The portion in the same color as that of the drawing sheet has no numerical value. It is noted that the loss mentioned therein refers to loss including a loss in the motor (copper loss, iron loss, or the like), a loss in the inverter (switching loss or the like), and a loss in the converter (switching loss or the like).

The inverter circuit 20 includes the switching elements 4a to 4f and diodes 9. Each of the diodes 9 is connected in antiparallel to a corresponding one of the switching elements 4a to 4f. Every two of the switching elements 4a to 4f are connected in series, and three such series-connection pairs are connected in parallel. The switching elements 4a to 4f are repeatedly turned on/off as appropriate through control by the power controller 8, and AC is outputted from an intermediate point of each of the series-connection pairs.

Between the voltage converter circuit 10 and the inverter circuit 20, a smoothing capacitor 12 is connected in parallel. The smoothing capacitor 12 is connected between the low-voltage end positive electrode 10b1 and the low-voltage end negative electrode 10b2 of the voltage converter circuit 10. The smoothing capacitor 12 suppresses pulsation of current flowing between the voltage converter circuit 10 and the inverter circuit 20.

The motor 13 is mounted with a rotation speed sensor 14 which measures the rotation speed of the motor 13. Data of the measured rotation speed is also transmitted to the power controller 8. The power controller 8 controls switching of the switching elements in the voltage converter circuit 10 and the inverter circuit 20 also in consideration of the rotation speed of the motor 13 measured by the rotation speed sensor 14.

The maximum drive voltage of the motor 13 is equal to the output voltage of the battery 11. That is, the motor 13 is operated at a voltage equal to or lower than the output voltage of the battery 11. If the degree of accelerator opening caused upon an accelerator operation by a driver increases, the drive voltage of the motor 13 increases. Meanwhile, if the degree of accelerator opening decreases, the drive voltage also decreases. In a case where the drive voltage of the motor 13 is lower than the output voltage of the battery 11, the power controller 8 operates the voltage converter circuit 10 such that the output voltage of the battery 11 is stepped down and supplied to the inverter circuit 20. As the motor 13, a motor having a variable gear ratio of ½ or higher, i.e., a motor in which the ratio between a rotation speed at a maximum output point and a maximum rotation speed is two times or higher, is used in the present embodiment. However, the motor 13 is not limited thereto. A motor having a higher variable gear ratio leads to a more significant efficiency-enhancing effect, and thus is more advantageous.

The power controller 8 and the higher-order controller 15 are connected to each other, and the higher-order controller 15 determines a target output torque of the motor 13 on the basis of information about the degree of accelerator opening and the like. The target output torque is transmitted to the power controller 8.

As described above, the drive voltage of the motor 13 is equal to or lower than the output voltage of the battery 11, and the power controller 8 having received the target output torque from the higher-order controller 15 determines a target voltage of the voltage converter circuit and a target frequency of the output AC of the inverter circuit 20. The power controller 8 controls the switching elements 3a and 3b of the voltage converter circuit 10 and the switching elements 4a to 4f of the inverter circuit 20 such that the target voltage and the target frequency having been determined are realized.

Meanwhile, the switching elements 3a and 3b and the reactor 5 have large heat generation amounts. Therefore, the power controller 8 controls the switching elements 3a and 3b so as to suppress heating of the reactor 5 and the switching elements 3a and 3b, in particular, the switching element 3a involved in step-down. If execution of no step-down operation leads to better efficiency, the power controller 8 controls the voltage converter circuit 10 such that the voltage of the low-voltage end 10b becomes equal to the voltage of the high-voltage end 10a. Specifically, the power controller 8 maintains the switching element 3a to be in an ON state and maintains the switching element 3b to be in an OFF state. By doing so, the high-voltage end positive electrode 10a1 and the low-voltage end positive electrode 10b1 enter a constantly connected state, and the voltages at both ends become equal to each other. Consequently, current no longer pulsates in association with ON/OFF of the switching elements 3a and 3b, and heat generation from the switching element 3a and the reactor 5 is suppressed.

The power controller 8 constantly monitors the temperature of the switching element 3a and the temperature of the reactor 5 through the temperature sensors 6 and 7. In a case where the temperature of the switching element 3a or the reactor 5 exceeds a predetermined temperature threshold value, the power controller 8 maintains the switching element 3a to be in an ON state and maintains the switching element 3b to be in an OFF state regardless of the magnitude of power consumed in the motor 13. That is, the power controller 8 controls the switching elements 3a and 3b such that the voltage of the high-voltage end 10a and the voltage of the low-voltage end 10b become equal to each other. By doing so, further increase of the temperatures of the switching element 3a and the reactor 5 can be prevented. The predetermined temperature threshold value refers to a protection temperature for preventing failure of the corresponding one of the switching elements 3a and 3b and the reactor 5. Overheating of the switching elements 3a and 3b or the reactor 5 can be prevented regardless of the magnitude of current flowing through the inverter circuit 20 or the magnitude of power consumed in the motor 13.

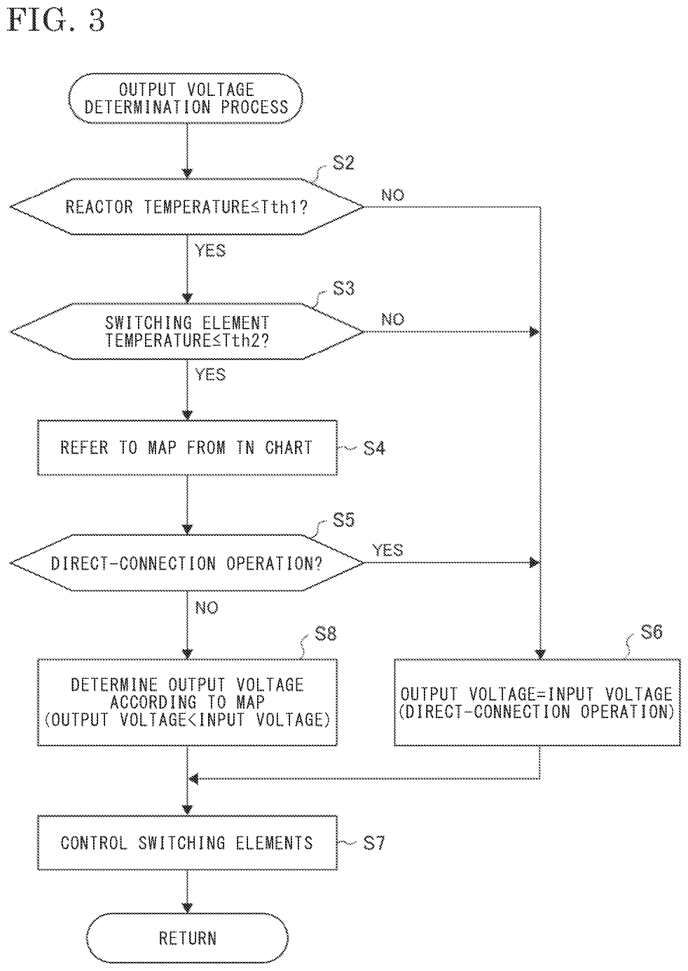

FIG. 3 is a flowchart of an output voltage determination process by the power controller 8. The process in FIG. 3 is periodically executed. The power controller 8 acquires data from each of the temperature sensors 6 and 7 and compares the data with the corresponding predetermined temperature threshold value. Specifically, the power controller 8 compares a measurement temperature from the temperature sensor 7, i.e., the temperature of the reactor 5, with a first temperature threshold value Tth1 (step S2 in FIG. 3). In a case where the temperature of the reactor 5 is higher than the first temperature threshold value Tth1, the power controller 8 causes a shift to a process in step S6 described later.

In a case where the temperature of the reactor 5 is equal to or lower than the first temperature threshold value Tth1, the power controller 8 compares a measurement temperature from the temperature sensor 6, i.e., the temperature of the switching element 3a, with a second temperature threshold value Tth2 (step S3). In a case where the temperature of the switching element 3a is higher than the second temperature threshold value Tth2, the power controller 8 causes a shift to the process in step S6 described later in the same manner as in the case of step S2.

In the process in step S6, the power controller 8 sets, as an output voltage, the same value as that of an input voltage. Then, the power controller 8 controls the switching elements 3a and 3b (step S7). In the case where step S6 has been executed, the power controller 8 performs, in step S7, a direct-connection operation of maintaining the switching element 3a to be in an ON state and maintaining the switching element 3b to be in an OFF state.

In a case where the temperature of the switching element 3a is equal to or lower than the second temperature threshold value Tth2, the power controller 8 refers to the loss map shown in FIG. 2 (step S4). In a case where it is determined that execution of a direct-connection operation leads to better efficiency (YES in step S5) as a result of referring to the step-down ratio shown in the TN chart, the power controller 8 performs the process in step S6. For example, in a region in which the rotation speed is low or the torque is low as shown in FIG. 2, heat generated from the voltage converter circuit 10 increases, and influence is inflicted on the efficiency of the motor. Thus, a direct-connection operation in which the step-down ratio in a region with a low color intensity on the loss map is set to 1 is performed.

In the direct-connection operation in which the step-down ratio is set to 1, the same value as that of the input voltage is set as an output voltage of the voltage converter circuit 10. In this case, as described above, the power controller 8 maintains the switching element 3a to be in an ON state and maintains the switching element 3b to be in an OFF state through control in step S7. As a result, pulsating current no longer flows through the switching element 3a and the reactor 5, and heat generation is suppressed.

Meanwhile, in a case where the step-down ratio is lower than 1, the power controller 8 determines an output voltage of the voltage converter circuit 10 on the basis of the rotation speed of the motor 13 (step S8). The output voltage is controlled to be lower than the input voltage. The switching elements 3a and 3b of the voltage converter circuit 10 are controlled such that the determined output voltage is realized (step S7). In a case where power that is supplied to the motor 13 is large, heat generation can be suppressed by maintaining the switching element 3a to be ON.

Although mapping of losses with the sum of the loss in the motor, the loss in the inverter, and the loss in the converter being minimized has been described in the present embodiment, any of the loss in the motor, the loss in the inverter, and the loss in the converter, or a combination of these losses, may be mapped. In this case, a step-down ratio is calculated such that each of the losses or the combination of the losses is minimum. It is noted that the loss in the motor may be set according to the temperature of a magnet of the motor.

As described above, in the present embodiment, the loss map in which loss is indicated on the TN chart is referred to so that a step-down ratio at which the loss is minimum is ascertained from a target rotation speed and a target output torque, whereby an output voltage is determined. Consequently, in a condition in which the heat generation amount of the converter is larger than the heat generation amount of the inverter during a low-output operation performed such that the motor is operated at a low rotation speed or a low torque, the switching element involved in step-down is maintained to be in an ON state, whereby the heat generation amount of the converter is reduced. Thus, control can be performed so as to improve the efficiency of the entirety composed of the motor, the inverter, and the converter.

### Second Embodiment

In FIG. 4, a power converter 2a includes a voltage converter circuit 110, the inverter circuit 20, and the power controller 8. The voltage converter circuit 110 has a high-voltage end 110a connected to the battery 11 and a low-voltage end 110b connected to the inverter circuit 20. The power converter 2a differs from the power converter 2 in the first embodiment in that the power converter 2a further includes an overcurrent protector 106 and a charging port 107. The other components are the same as those in the first embodiment, and thus descriptions of the components other than the overcurrent protector 106 and the charging port 107 will be omitted.

The switching element 3b and the overcurrent protector 106 are connected in series between a positive line 19a and a negative line 19b of the voltage converter circuit 110. The overcurrent protector 106 is a fuse that melts when current having at least a predetermined magnitude flows therethrough. The voltage converter circuit 110 is a bidirectional DC-DC converter, and the switching element 3b is involved in step-up operation. The switching element 3b is connected between the positive line 19a and the negative line 19b. Thus, when the switching element 3b experiences a short-circuit failure, short-circuiting occurs between the positive line 19a and the negative line 19b so that large current flows. However, the overcurrent protector 106 immediately melts when such large current flows therethrough, whereby the positive line 19a and the negative line 19b are disconnected from each other so that the short-circuiting is eliminated. If the positive line 19a and the negative line 19b are disconnected from each other, the voltage converter circuit 110 cannot perform step-down operation, either. In this case, the power controller 8 maintains the switching element 3a to be ON. If the switching element 3a is maintained to be ON, a high-voltage end positive electrode 110a1 and a low-voltage end positive electrode 110b1 enter a directly connected state, and power of the battery 11 directly flows to the inverter circuit 20. Therefore, the same voltage as the input voltage can be outputted, and, even after the overcurrent protector 106 has been operated, the traveling motor can be continuously driven. Consequently, an electric automobile 91 can continuously travel.

The charging port 107 is connected between the low-voltage end positive electrode 110b1 and a low-voltage end negative electrode 110b2 of the voltage converter circuit 110. An external power supply can be connected to the charging port 107. Since the voltage converter circuit 110 is a bidirectional DC-DC converter, the voltage converter circuit 110 can step up a voltage inputted to the low-voltage end 110b and output the resultant voltage from the high-voltage end 110a. Therefore, the battery 11 can be charged while an external power supply having a voltage lower than the voltage of the battery 11 is connected to the charging port 107.

As a modification of the present second embodiment, a configuration in which the power converter 2a does not include the switching element 3b may be employed. Such a voltage converter circuit 110 cannot perform step-up operation, but can perform step-down operation. In this case, a diode 9a and the overcurrent protector 106 are connected in series between the positive line 19a and the negative line 19b. Even in a case where large current flows between the positive line 19a and the negative line 19b as a result of a short-circuit failure of the diode 9a, the overcurrent protector 106 melts, whereby the positive line 19a and the negative line 19b are disconnected from each other. In this case as well, the power controller 8 maintains the switching element 3a to be in an ON state, whereby the electric automobile 91 can continuously travel.

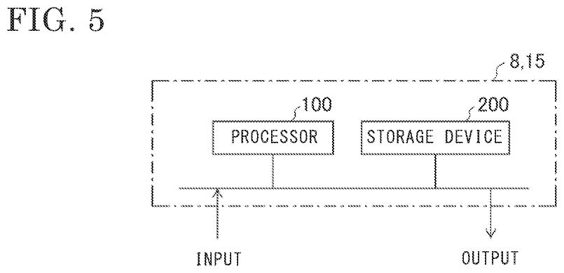

An example of hardware of each of the power controller 8 and the higher-order controller 15 is shown in FIG. 5. The hardware is composed of a processor 100 and a storage device 200. Although not shown, the storage device 200 includes a volatile storage device such as a random access memory, and a nonvolatile auxiliary storage device such as a flash memory. Alternatively, the storage device may include, as the auxiliary storage device, a hard disk instead of a flash memory. The processor 100 executes a program inputted from the storage device 200, thereby, for example, determining an output voltage for which the above map has been referred to. In this case, the program is inputted from the auxiliary storage device via the volatile storage device to the processor 100. Further, the processor 100 may output data such as a computation result to the volatile storage device of the storage device 200 or may save the data via the volatile storage device into the auxiliary storage device.

As described above, in a case where it is determined that execution of a direct-connection operation leads to a lower loss as a result of referring to the loss map, the output voltage is set to be equal to the input voltage in the above embodiments. However, it is also possible to, instead of referring to the loss map, monitor an input voltage and an output current (input for the motor) of the inverter circuit 20, thereby determining a total loss of the loss in the inverter and the loss in the motor 13 and changing the output voltage. Current flowing through the reactor 5 of the voltage converter circuit 10, i.e., current measured by the current sensor 16, is supplied to the inverter circuit 20. Therefore, current flowing through the inverter circuit 20 can be measured by the current sensor 16 of the voltage converter circuit 10. In addition, the power controller 8 may be configured to set the output voltage to be equal to the input voltage in a case where the motor 13 has a rotation speed equal to or lower than a predetermined rotation speed and has a torque value equal to or smaller than a predetermined torque value.

Although the battery 11 corresponds to an example of the DC power supply, the DC power supply may be a fuel cell. The voltage of the DC power supply is desirably 500 V or higher.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the specification of the present disclosure. For example, at least one of the constituent components may be modified, added, or eliminated. At least one of the constituent components mentioned in at least one of the preferred embodiments may be selected and combined with the constituent components mentioned in another preferred embodiment. The technologies presented as examples in the present specification or the drawings can concurrently accomplish a plurality of objects, and accomplishment of one of the objects itself leads to technical utility.

Hereinafter, modes of the present disclosure are summarized as additional notes.

(Additional Note 1)

A power conversion device for converting power of a DC power supply into drive power for a traveling motor, the power conversion device comprising:
an inverter which supplies AC power to the traveling motor;
a converter which controls switching of a switching element and applies a voltage of the DC power supply to the inverter; and
a controller which controls the converter, wherein
the controller controls the switching element according to a torque and a rotation speed of the traveling motor on the basis of a loss in at least one of the traveling motor, the inverter, and the converter.

(Additional Note 2)

The power conversion device according to additional note 1, wherein
the controller controls the switching element according to the torque and the rotation speed of the traveling motor on the basis of a step-down ratio, of the converter, at which a sum of a loss in the traveling motor, a loss in the inverter, and a loss in the converter is minimum.

(Additional Note 3)

The power conversion device according to additional note 2, wherein
the step-down ratio is mapped on a TN chart based on the torque and the rotation speed of the traveling motor, and
the controller controls the switching element of the converter according to the torque and the rotation speed of the traveling motor by referring to the step-down ratio having been mapped.

(Additional Note 4)

The power conversion device according to additional note 3, wherein
mapping is performed on a region in which the step-down ratio is 1.

(Additional Note 5)

The power conversion device according to additional note 3 or 4, wherein
in a case where the step-down ratio is 1, the switching element is controlled such that an input voltage and an output voltage of the converter become equal to each other.

(Additional Note 6)

The power conversion device according to additional note 1 or 2, wherein
a loss in the traveling motor is set according to a temperature of a magnet having been provided.

(Additional Note 7)

The power conversion device according to additional note 1, wherein
a loss in each of the traveling motor and the inverter is determined on the basis of current flowing through the inverter.

(Additional Note 8)

The power conversion device according to additional note 1, wherein
in a case where the traveling motor has a rotation speed equal to or lower than a rotation speed predetermined on the basis of the loss and has a torque value equal to or smaller than a torque value predetermined on the basis of the loss, the controller performs switching control such that an output voltage of the converter becomes equal to an input voltage of the converter.

(Additional Note 9)

The power conversion device according to any one of additional notes 1 to 8, wherein
the traveling motor is a motor in which a ratio between a rotation speed at a maximum output point and a maximum rotation speed is two times or higher.

(Additional Note 10)

The power conversion device according to any one of additional notes 1 to 9, wherein
the voltage of the DC power supply is 500 V or higher.

(Additional Note 11)

The power conversion device according to any one of additional notes 1 to 10, wherein
the switching element is a wide bandgap semiconductor.

(Additional Note 12)

The power conversion device according to any one of additional notes 1 to 11, wherein
the converter is a multilevel chopper.

(Additional Note 13)

The power conversion device according to any one of additional notes 1 to 12, wherein
a magnetically coupled reactor is used for the converter.

### DESCRIPTION OF THE REFERENCE CHARACTERS

2, 2a power converter
3a, 3b, 4a to 4f switching element
5 reactor
6, 7 temperature sensor
8 power controller
9, 9a diode
10, 110 voltage converter circuit
11 battery
12 smoothing capacitor
13 motor
14 rotation speed sensor
15 higher-order controller
16 current sensor
20 inverter circuit
90, 91 electric automobile
106 overcurrent protector
107 charging port

What is claimed is:

1. A power conversion device for converting power of a DC power supply into drive power for a traveling motor, the power conversion device comprising:
an inverter which supplies AC power to the traveling motor;
a converter which controls switching of a switching element and applies a voltage of the DC power supply to the inverter; and
a controller which controls the converter, wherein
the controller controls the switching element according to a torque and a rotation speed of the traveling motor on the basis of a loss in at least one of the traveling motor, the inverter, and the converter.

2. The power conversion device according to claim 1, wherein
the controller controls the switching element according to the torque and the rotation speed of the traveling motor on the basis of a step-down ratio, of the converter, at which a sum of a loss in the traveling motor, a loss in the inverter, and a loss in the converter is minimum.

3. The power conversion device according to claim 2, wherein
the step-down ratio is mapped on a TN chart based on the torque and the rotation speed of the traveling motor, and
the controller controls the switching element of the converter according to the torque and the rotation speed of the traveling motor by referring to the step-down ratio having been mapped.

4. The power conversion device according to claim 3, wherein
mapping is performed on a region in which the step-down ratio is 1.

5. The power conversion device according to claim 3, wherein
in a case where the step-down ratio is 1, the switching element is controlled such that an input voltage and an output voltage of the converter become equal to each other.

6. The power conversion device according to claim 1, wherein
a loss in the traveling motor is set according to a temperature of a magnet having been provided.

7. The power conversion device according to claim 1, wherein
a loss in each of the traveling motor and the inverter is determined on the basis of current flowing through the inverter.

8. The power conversion device according to claim 1, wherein
in a case where the traveling motor has a rotation speed equal to or lower than a rotation speed predetermined on the basis of the loss and has a torque value equal to or smaller than a torque value predetermined on the basis of the loss, the controller performs switching control such that an output voltage of the converter becomes equal to an input voltage of the converter.

9. The power conversion device according to claim 1, wherein
the traveling motor is a motor in which a ratio between a rotation speed at a maximum output point and a maximum rotation speed is two times or higher.

10. The power conversion device according to claim 1, wherein
the voltage of the DC power supply is 500 V or higher.

11. The power conversion device according to claim 1, wherein
the switching element is a wide bandgap semiconductor.

12. The power conversion device according to claim 1, wherein
the converter is a multilevel chopper.

13. The power conversion device according to claim 12, wherein
a magnetically coupled reactor is used for the converter.

14. The power conversion device according to claim 4, wherein
in a case where the step-down ratio is 1, the switching element is controlled such that an input voltage and an output voltage of the converter become equal to each other.

15. The power conversion device according to claim 2, wherein
a loss in the traveling motor is set according to a temperature of a magnet having been provided.
